(19) United States
(12) Patent Application Publication
(10) Pub. No.: US 2025/0139554 A1
(43) Pub. Date: May 1, 2025

(54) METHODS AND SYSTEMS FOR ACTIVITY FRAMEWORK GENERATION

(71) Applicant: JP Morgan Chase Bank, N.A., New York, NY (US)

(72) Inventors: Sitalakshmi NARAYANAN, Singapore (SG); Jatin R. GALIA, Mumbai (IN); Apurv SHETH, Surat (IN); Jayaprabhu KABALI SARAVANAN, Singapore (SG)

(73) Assignee: JP Morgan Chase Bank, N.A., New York, NY (US)

(21) Appl. No.: 18/399,427

(22) Filed: Dec. 28, 2023

(30) Foreign Application Priority Data
Oct. 27, 2023 (IN) 202311073273

(51) Int. Cl. G06Q 10/0633

(52) U.S. Cl. CPC G06Q 10/0633

(57) ABSTRACT

There are provided systems and methods for generating, configuring, or reconfiguring activity frameworks. For instance, there is provided a method for configuring an activity framework. The method can reside as instructions on a non-transitory computer-readable medium, the instructions being configured to cause a processor to perform certain operations. The operations may include receiving a set of requirements and constructing a set of computational steps required to meet the set of requirements. The operations can further include generating the activity framework and the activity framework can include a workflow of activities. The operations can further include generating a configuration file.

### CROSS REFERENCE TO RELATED APPLICATIONS

This application claims priority from Indian Provisional Application No. 202311073273, filed Oct. 27, 2023, entitled “Methods and Systems for Activity Framework Generation,” the contents of which are hereby incorporated by reference.

### FIELD OF TECHNOLOGY

The present disclosure relates to a technological infrastructure for onboarding clients with different technical requirements.

### BACKGROUND

A business-to-business interaction is defined by the mutual understanding of requirements from each party in the interaction. For example, the technological infrastructure of a first business must be able to accommodate the requirements of a second business which the first business wishes to onboard for the purpose of providing services to the second business. As such, the second business' requirements must be codified in such a way that the first business can render the sought services properly.

While it is possible to code such requirements and provide a technological framework for enabling the rendering of services, from the point of view of the first business, it becomes difficult to scale such a workflow when it seeks to onboard a plurality of businesses that have widely disparate requirements. Moreover, it becomes difficult to maintain the activity framework between the two parties when the initial set of requirements is updated.

For example, consider a scenario where an offerer of services provides access to those services via application programing interfaces (APIs) and that a first business wishes to connect to an API based on their own requirement. Further, another business wishes to connect to another API because they have a different set of requirements than the first business. From the offerer's point of view, each of these businesses requires a specific onboarding workflow to support their activity framework. These requirements result in significant engineering time for designing, developing, and testing dedicated infrastructures for each client. As a result, conventional approaches are costly, time-consuming, and resource-intensive.

### SUMMARY

Given the aforementioned deficiencies, there is a technological need for an activity framework that facilitates the onboarding of multiple businesses without an onerous onboarding workflow and that provides a streamlined and efficient method to update existing requirements. The embodiments featured herein provide low-overhead processes that streamline the onboarding processes across different client requirements and needs.

The embodiments also provide a low-code and conflict-driven process for onboarding different businesses having different requirements. For example, and not by limitation, such requirements may be a particular protocol for orchestrating data, i.e., processes to stich data structures together from a plurality of sources, to collect and separate data streams, or to merge data originating from various sources.

The embodiments provide an activity framework that emphasizes the use of configuration to control the behavior of an application and that boost an open-close principle. The behavior is defined through a series of configuration files that can be modified without the need to modify the underlying source code which significantly reduces the turnaround time typically required to release a solution.

The configuration files typically contain a set of activities that control how the application operates. These files also provide a platform to present workflows of computational logic with basic coding constructs such as loop, parallel computation, API calls, and the marshaling, for example, of JavaScript object notation (JSON) objects. The embodiments further provide an activity framework that offers flexibility of process flow definitions along with support for merging data, collecting data, filtering data, grouping data, defining sub processes, parallel execution, and output processing. Two example embodiments are described briefly below.

A first example embodiment provides a method for configuring an activity framework. The method can reside as instructions on a non-transitory computer-readable medium, the instructions being configured to cause a processor to perform certain operations. The operations may include receiving a set of requirements and constructing a set of computational steps required to meet the set of requirements. The operations can further include generating the activity framework and the activity framework can include a workflow of activities. The operations can further include generating a configuration file.

A second example embodiment provides a system for configuring an activity framework. The exemplary system can include a memory and a processor, which when executing instructions from the memory, is configured to perform certain operations. The operations may include receiving a set of requirements and constructing a set of computational steps required to meet the set of requirements. The operations can further include generating the activity framework and the activity framework can include a workflow of activities. The operations can further include generating a configuration file.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an activity framework system according to several aspects of the present disclosure.

FIG. 2 illustrates a sample activity framework potentially generated by the system depicted in FIG. 1, in accordance with the embodiments.

FIG. 3 illustrates a system according to several aspects of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

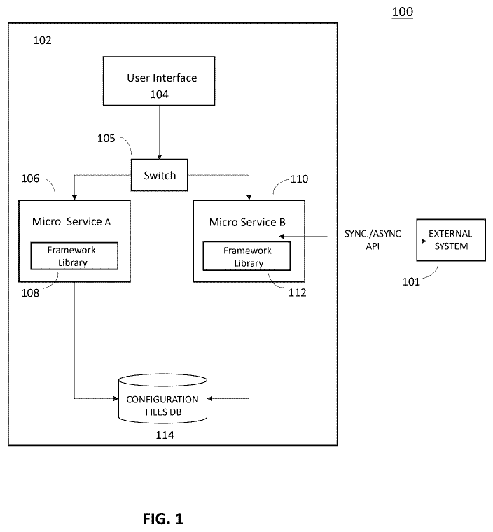

FIG. 1 illustrates an activity framework generation system 100. The system 100 may be configured to receive a set of requirements from an external system 101. Reception of requirements may be affected via, for example, by a synchronous or asynchronous API. Upon receiving the set of requirements, a computing system 102 of the system 100 may include a plurality of micro-services embodied in memories of the computing systems as processor-executable instructions.

For instance, there may be, as shown FIG. 1, a routine associated with a micro-service A, denoted 106. Similarly, there may be a routine associated with a micro-service B, denoted 110. The micro-services A and B may each have an activity framework library associated with them, such as libraries 108 and 112, respectively. The system computing system 102 may be configured to generate, from the activity framework libraries 108 and 112, a set of configuration files that may be stored in database (DB) 114.

The configuration files embody the set of requirements provided by the external system 101, and no coding is thus required. The computing system 102 can further include a user interface (UI) 104, which may allow a user to effect technical changes in the subsystems of the computer system 102 via a switch or router 105, as they relate to the available micro-services 106 and 110, and the database 114.

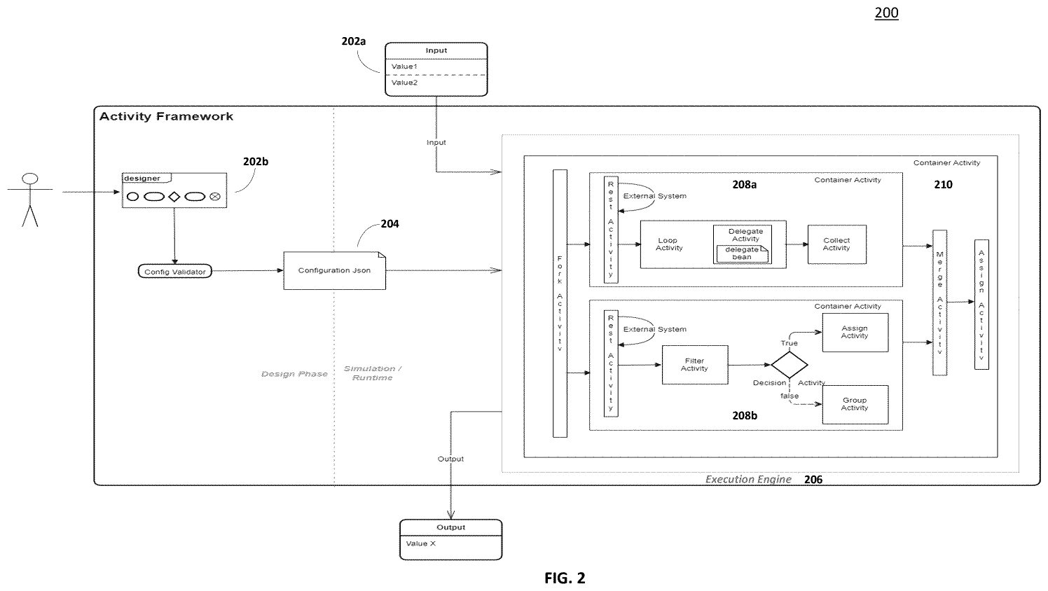

FIG. 2 illustrates an activity framework 200 that may be generated by the system 100 of FIG. 1 above. The activity framework 200 may include a set of input parameters (202a, 202b), which may be inputted by a user or by a remote system. The inputs 202a and 202b do not require coding, as the activity framework leverages the pre-configured configuration files (e.g., .json files 204).

From the configuration files 204, along with the inputs 202a and 202b, the activity framework 200 can execute an engine 206 to perform a plurality of activities (e.g., activities 208a and 208b). These activities are executed according to the configuration files 204, and they may be executed independently, sequentially, or simultaneously as part of an activity container 210. The execution engine can provide one or more outputs 212 that are consistent with the activity framework 200 and that satisfy the initial requirements received from the external system 101 in FIG. 1.

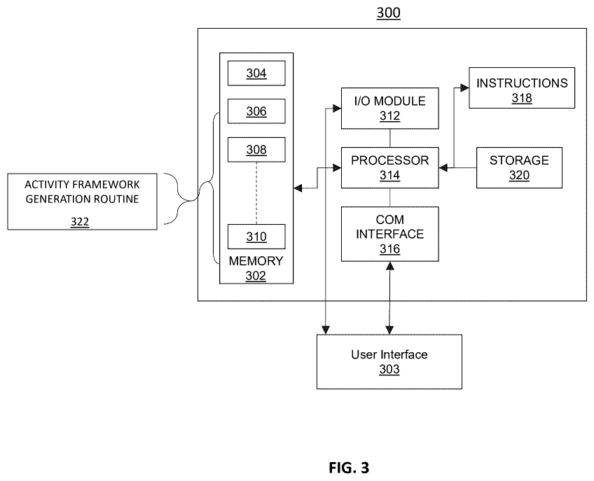

FIG. 3 illustrates a system 300 that may be an application-specific hardware, software, and firmware implementation (or a combination thereof) of the system 100 as it is configured to execute the methods described herein and is a structural and application-specific implementation of an activity framework generation system, such as the system 100. The system 300 can include a processor 314 configured to executed one or more, or all of the steps of the methods described herein throughout the instant disclosure.

The processor 314 can have a specific structure. The specific structure can be imparted to the processor 314 by instructions stored in a memory 302 and/or by instructions 418 fetchable by the processor 314 from a storage medium 320. The storage medium 320 may be co-located with the system 300 as shown, or it can be remote and communicatively coupled to the system 400. Such communications can be encrypted.

The system 300 can be a stand-alone programmable system, or a programmable module included in a larger system. For example, the system 300 can be included in an activity framework generation infrastructure. The system 300 may include one or more hardware and/or software components configured to fetch, decode, execute, store, analyze, distribute, evaluate, and/or categorize information.

The processor 314 may include one or more processing devices or cores (not shown). In some embodiments, the processor 314 may be a plurality of processors, each having either one or more cores. The processor 314 can execute instructions fetched from a memory 302, i.e., from one of memory modules 304, 306, 308, or 310. Alternatively, the instructions can be fetched from the storage medium 320, or from a remote device connected to the system 100 via a communication interface 316. An input/output (I/O) module 312 may be configured for additional communications to or from remote systems or to a user interface 303 from which the processor 314 may receive a set of requirements.

Without loss of generality, the storage medium 320 and/or the memory 302 can include a volatile or non-volatile, magnetic, semiconductor, tape, optical, removable, non-removable, read-only, random-access, or any type of non-transitory computer-readable computer medium. The storage medium 320 and/or the memory 302 may include programs and/or other information usable by processor 314, such as for example, instructions that embody the processor 314 to execute the activity framework generation methods described herein. Furthermore, the storage medium 320 can be configured to log data processed, recorded, or collected during the operation of the system 300.

The data may be time-stamped, location-stamped, cataloged, indexed, encrypted, and/or organized in a variety of ways consistent with data storage practice. By way of example, the memory modules 306-310 can form instructions that embody a method for generating, configuring, or re-configuring an activity framework. In other words, the memory modules 306-310 may form, or embody, an activity framework generation routine 322 that causes the processor 314 to perform certain operations, upon execution. The operations may include receiving a set of requirements and constructing a set of computational steps required to meet the set of requirements. The operations can further include generating the activity framework and the activity framework can include a workflow of activities. The operations can further include generating a configuration file.

The set of requirements can include a requirement for a first computer system to interact with a chain of systems. Furthermore, the input and output of the chain of systems depend on a previous response from an API. The set of requirements can further include a set of rules associated with executing a subsequent activity from the activity framework. Furthermore, in the set of computational steps, each computational step is broken into corresponding activities.

The configuration file 204 obviates the need for writing code. The configuration file 204 supports executing a single activity from the activity framework. It can further support the execution of set of activities which are a process wrapper for multiple activities. The configuration file 204 may further support holding and executing an activity in a context-called activity, and it can further support clearing an execution of a previous activity.

Having described aspects of several particular embodiments in detail in their structure, function, and implementation, the teachings presented herein are now described in terms of general embodiments. For instance, one such embodiment provides a method for configuring an activity framework. The method can reside as instructions on a non-transitory computer-readable medium, the instructions being configured to cause a processor to perform certain operations. The operations may include receiving a set of requirements and constructing a set of computational steps required to meet the set of requirements. The operations can further include generating the activity framework and the activity framework can include a workflow of activities. The operations can further include generating a configuration file.

The set of requirements can include a requirement for a first computer system to interact with a chain of systems. Furthermore, the input and output of the chain of systems depend on a previous response from an API. The set of requirements can further include a set of rules associated with executing a subsequent activity from the activity framework. Furthermore, in the set of computational steps, each computational step is broken into corresponding activities. The configuration file obviates the need for writing code. The configuration file supports executing a single activity from the activity framework. It can further support the execution of set of activities which are a process wrapper for multiple activities. The configuration file can further support holding executing an activity in a context-called activity, and it can further support clearing an execution of a previous activity.

Another general embodiment provides a system for configuring an activity framework. The exemplary system can include a memory and a processor, which when executing instructions from the memory, is configured to perform certain operations. The operations may include receiving a set of requirements and constructing a set of computational steps required to meet the set of requirements. The operations can further include generating the activity framework and the activity framework can include a workflow of activities. The operations can further include generating a configuration file.

The set of requirements can include a requirement for a first computer system to interact with a chain of systems. Furthermore, the input and output of the chain of systems depend on a previous response from API. The set of requirements can further include a set of rules associated with executing a subsequent activity from the activity framework. Furthermore, in the set of computational steps, each computational step is broken into corresponding activities.

The configuration file obviates the need for writing code. The configuration file supports executing a single activity from the activity framework. It can further support the execution of set of activities which are a process wrapper for multiple activities. The configuration file can further support holding executing an activity in a context-called activity, and it can further support clearing an execution of a previous activity.

In the embodiments, for any large platform, there is requirement across eco systems to communicate with services within/across eco systems as well as other external systems. API Integration library was developed for the similar need for Unity platform which had to communicate across its echo systems like capture, case eco systems and to external sources like PTR, irecs, etc. for various use cases like enrichment, investigation, resolution, entitlement validation, allocation, assignment, prioritization, etc.

Based on various business scenarios there is need for communication-either by SYNC over APIs or ASYNC over kafka between the services/systems. Given that each service/system has their own request/response structure, authentication mechanisms, each calling (consumer) system has a need to write code to create request to the producer out of its data set, establish communication over a channel, retrieve response back and marshal it back to its data set. Because this is a common pattern across all services, there is a need for API Integration Library.

API Integration Libraries offer several features including: being written in Java; works based on a JSON configuration; abstracts SYNC/ASYNC communication from the core functionality which enables the services to focus on business logic rather than API integration; creates request to services based on robust attribute mapping; abstracts out the authentication mechanism which requires the services to just add the authentication properties to the environment configuration and not worry about the communication; abstracts out API invocation; and marshals the response sent by services to the required format based on attribute mapping.

API integration libraries may also be integrated with unity-kafka-connector-library to support ASYNC communication; integrated with unity-config-engine-library to abstract out API configuration at an environment level (Meaning the API call configuration json can be stored with config type “ApiConfiguration” and a config id (say api1) in your config table. Once stored, when APIIntegrationStarterTemplate is invoked with the particular config id (say api1 in this example) and input, the library will fetch the configuration json from the config table and perform the integration based on the configuration and send back the response back to the caller.

API integration libraries may also supports an ability to have different authentication mechanisms at every environment level—For example, dev urls will not require any authentication, whereas UAT and PROD will require connections to be authenticated over IDA; supports retry based on HTTP statuses for a specified number of times over a specified interval; supports ability to specify read timeout and connection time out; and supports Async and Sync channels.

By way of example, sync API Types supported include REST, SOAP, and GRAPHQL. Sync authentication mechanisms (Connection Types) supported include IDA, JANUS, DEFAULT, BASIC_OAUTH, PASS_THROUGH.

API integration librarirequestsate over a configuration which specifies the API to connect, how to create request, how to map response back, how to handle retries in terms of failure. For each API connection, a need exists to create a JSON, that may be called for example apiCallConfiguration and can be given to the library along with the data to perform the integration.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A method for configuring an activity framework, the method residing as instructions on a non-transitory computer-readable medium, the instructions being configured to cause a processor to perform operations comprising:
receiving, in a memory associated with the processor, a set of requirements;
constructing, via the processor, a set of computational steps required to meet the set of requirements;
generating, based on the set of computational steps, an activity framework, the activity framework including a workflow of activities; and
producing a configuration file, responsive to the generated activity framework.

2. The method of claim 1, wherein the set of requirements includes a requirement for a first computer system to interact with a chain of systems wherein input and output of said chain of systems depend on a previous response from an application programming interface (API).

3. The method of claim 2, wherein the set of requirements further includes a set of rules associated with executing a subsequent activity from the activity framework.

4. The method of claim 1, wherein in the set of computational steps, each computational step is broken into corresponding activities.

5. The method of claim 1, wherein the configuration file obviates the need for writing code.

6. The method of claim 1, wherein the configuration file supports executing a single activity from the activity framework.

7. The method of claim 1, wherein the configuration file supports execution of set of activities.

8. The method of claim 7, wherein the set of activities is a process wrapper for multiple activities.

9. The method of claim 1, wherein the configuration file supports holding executing an activity in a context-called activity.

10. The method of claim 1, wherein the configuration file supports clearing an execution of a previous activity.

11. A system for configuring an activity framework, the system comprising:
a memory;
a processor, which when executing instructions from the memory, is configured to perform operations including:
receiving, via the memory, a set of requirements;
constructing, via the processor, a set of computational steps required to meet the set of requirements;
generating, via the processor, an activity framework, the activity framework including a workflow of activities; and
producing a configuration file, responsive to the generated activity framework.

12. The system of claim 11, wherein the set of requirements includes a requirement for a first computer system to interact with a chain of systems.

13. The system of claim 11, wherein the set of requirements further includes a set of rules associated with executing a subsequent activity from the activity framework.

14. The system of claim 11, wherein in the set of computational steps, each computational step is broken into corresponding activities.

15. The system of claim 11, wherein the configuration file obviates the need for writing code.

16. The system of claim 11, wherein the configuration file supports executing a single activity from the activity framework.

17. The system of claim 11, wherein the configuration file supports execution of set of activities.

18. The system of claim 17, wherein the set of activities is a process wrapper for multiple activities.

19. The system of claim 12, wherein the input and output of said chain of systems depend on a previous response from an application programming interface (API).

20. A non-transitory computer-readable medium having instructions stored thereon on, the instructions, when executed, cause a processor to perform a method comprising:
receiving, in a memory associated with the processor, a set of requirements;
constructing, via the processor, a set of computational steps required to meet the set of requirements;
generating, via the processor, an activity framework, the activity framework including a workflow of activities; and
producing a configuration file responsive to the generated activity framework.
